(19) United States
(12) Patent Application Publication
(10) Pub. No.: US 2003/0165116 A1
(43) Pub. Date: Sep. 4, 2003

(54) Traffic shaping procedure for variable-size data units

(76) Inventors: Michael F. Fallon, Mendon, MA (US); Makaram Raghunandan, Northborough, MA (US)

Correspondence Address: FISH & RICHARDSON, PC, 4350 LA JOLLA VILLAGE DRIVE, SUITE 500, SAN DIEGO, CA, 92122, US

(21) Appl. No.: 10/087,598

(22) Filed: Mar. 1, 2002

(51) Int. Cl. H04L 12/16

(52) U.S. Cl. 370/230.1; 370/411; 370/252

(57) ABSTRACT

Shaping data transmitted in a communication system includes determining whether to authorize transmission of received data having a variable size within a predetermined range. The determination is based on whether a predetermined amount of a time-based variable has substantially elapsed, the predetermined amount being related to a rate shaping criterion, and the determination is made without regard to the size of the received data.

### TECHNICAL FIELD

This invention relates generally to communication systems, and more particularly to rate shaping of flows on communication links.

### BACKGROUND

Rate shaping is used to modify the traffic on a communication link, for example, to restrict the data rate. Particular systems may restrict both a long-term average data rate and a short-term burst rate. These restrictions may arise, for example, from either physical constraints or allocation constraints.

### DESCRIPTION OF DRAWINGS

FIGS. 1-3 are block diagrams of systems for rate shaping transmitted data.

FIG. 4 is a block diagram of a device for rate shaping transmitted data.

FIG. 5 shows pseudocode of a process associated with rate shaping transmitted data.

FIGS. 6-10 are flow charts of processes associated with rate shaping transmitted data.

### DETAILED DESCRIPTION

A method is provided for shaping data transmitted in a communication system. Initially, a determination is made as to whether to authorize transmission of received data having a variable size that falls within a predetermined range. The determination is based on whether a predetermined amount of a time-based variable has elapsed, with the predetermined amount being related to a rate shaping criterion, and, the determination is made without regard to the size of the received data. Next, transmission is authorized if the predetermined amount of the time-based variable has elapsed. Finally, if transmission was authorized, a determination is made as to another value for the time-based variable that must elapse before a further transmission can be authorized.

Another method for shaping data transmitted in a communication system begins with the transmission of data having a variable size that falls within a predetermined range. Thereafter, new data are not transmitted until a predetermined amount of a time-based variable has elapsed, with the predetermined amount being related to a rate shaping criterion and to the size of the data.

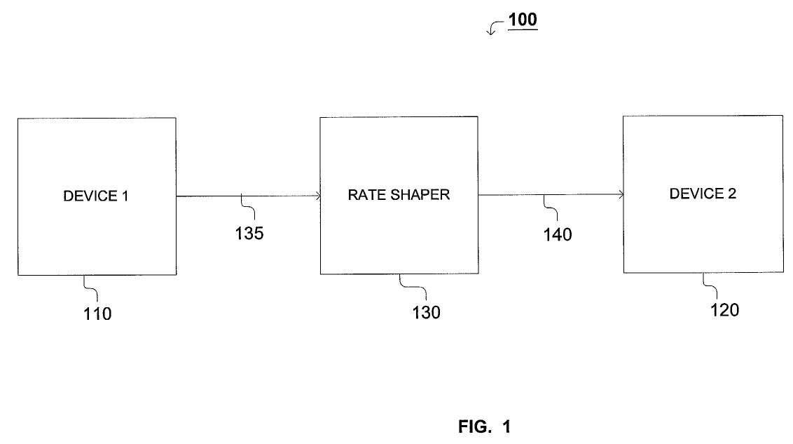

FIG. 1 shows a system 100 that uses rate shaping, also referred to as traffic shaping, bandwidth management, or link sharing, between two communicating devices 110, 120. The rate shaping is implemented by a rate shaper 130 that receives data from the first device 110 over a link 135 and shapes the data before transmitting the data over a link 140 to the second device 120.

The data may be characterized, for example, by being received at high and variable data rates and being transmitted at lower data rates. The lower data rates may be imposed, for example, by the physical bandwidth of the link 140, the bandwidth allocation, or cost constraints. When the input rate is variable and the output rate is fixed, the rate shaper 130 buffers the data, a task referred to as jitter buffer management. Jitter buffer management is commonly needed with packet networks, but also can be used with non-packet networks.

In performing the rate shaping, rate shaper 130 ensures that the relevant rate-shaping criteria are satisfied. Such criteria may include, for example, a maximum long-term data rate and a maximum burst data rate. Rate shaper 130 can perform a variety of actions to ensure that the rate-shaping criteria are satisfied. These actions include, for example, deleting received data if transmission of such data would exceed a rate-shaping criterion, or buffering such data for later transmission.

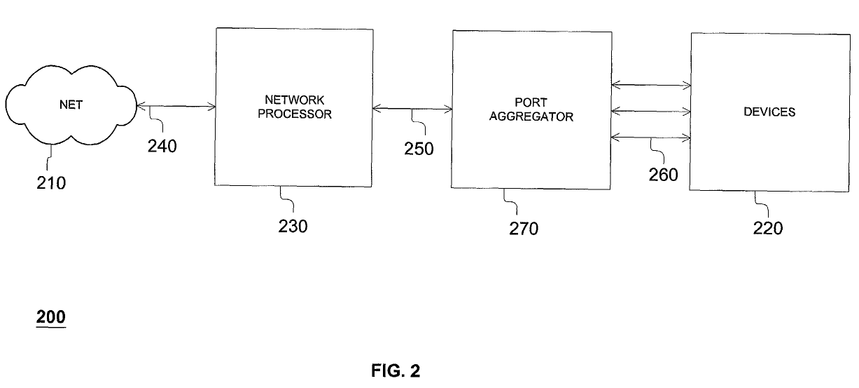

FIG. 2 shows a system 200 in which data are communicated between a network 210 and devices 220. In the system 200, a network processor 230 (analogous to rate shaper 130 in FIG. 1) performs rate shaping on, for example, data received over link 240 and transmitted over links 250, 260. In one implementation, link 250 is a high data-rate link. In various implementations, link 260 can be, for example, a group of OC-3 (“Optical Carrier”) links, a group of DSL (“Digital Subscriber Line” or “Digital Subscriber Loop”) lines, or a group of cable links connecting to cable modems in devices 220. A port aggregator 270 receives the data transmitted over link 250 and directs the data to the appropriate link 260. In various implementations, the system 200 may represent, for example, data being transmitted from the World Wide Web, or another network, to a personal computer in a user's home. In one implementation, the network processor 230 also performs rate shaping on the data being transmitted from the devices 220 to the network 210.

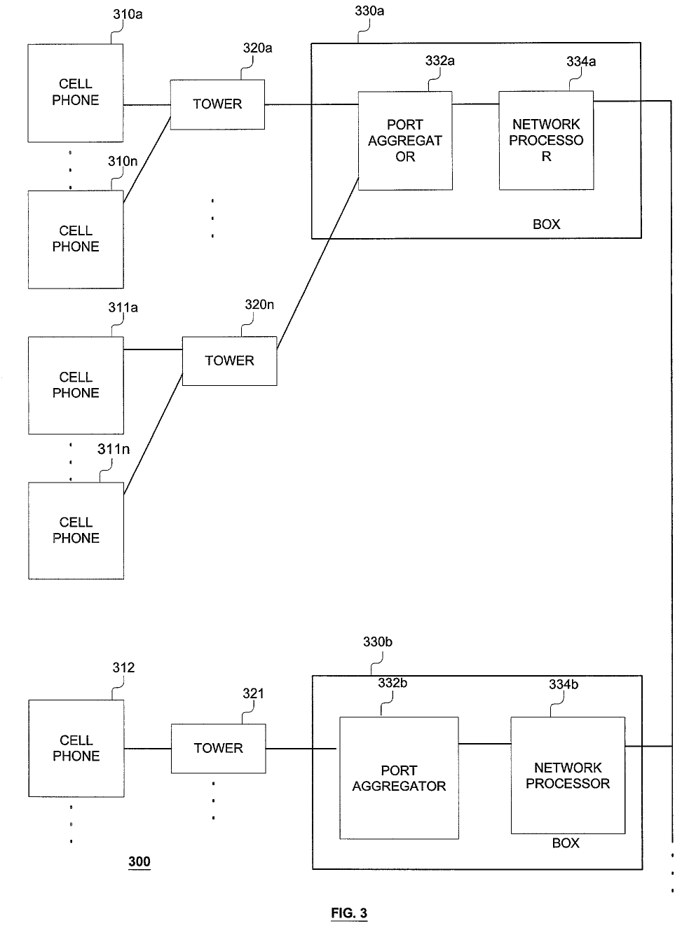

FIG. 3 shows another system 300 in which rate shaping is used. In particular, FIG. 3 shows the communication paths between cellular (“cell”) phones. Cell phones 310a-310n communicate with a tower 320a. Cell phones 311a-311n communicate with a tower 320n. Towers 320a-320n communicate with a box 330a. Box 330a communicates with a box 330b and a series of other boxes (indicated by the ellipses). The communication paths indicated need not be exclusive and other configurations can be adopted when warranted by a particular application.

Box 330a contains a port aggregator 332a and a network processor 334a. Port aggregator 332a is analogous to port aggregator 270 in the system 200 of FIG. 2 and performs, for example, the multiplexing and demultiplexing of the data transmitted to and received from, respectively, network processor 334a. The multiplexing and demultiplexing are necessary because port aggregator 332a communicates with each of the towers 320a-320n over a different link. Network processor 334a is analogous to network processor 230 in the system 200 of FIG. 2 and performs, for example, the rate shaping of data being transmitted to cell phones 310a-310n, 311a-311n and the other cell phones communicating with towers 320a-320n.

Elements 312, 321, 330b, 332b, and 334b are analogous to elements 310a, 320a, 330a, 332a, and 334a, respectively. Thus, cell phone 310a communicates with cell phone 312 through tower 320a, port aggregator 332a, network processor 334a, network processor 334b, port aggregator 332b, and tower 321.

System 300 illustrates that multiple cell phones may be receiving data through a network processor at any given time. The data stream for each of these cell phones is referred to as a flow, and the network processor performs rate shaping separately on each flow. In performing the rate shaping, the network processor ensures that the relevant rate-shaping criteria are satisfied for each flow. The network processor can also perform rate shaping based on the data being transmitted to a particular tower, in which case the “flow” would refer to all data transmitted to that tower. As indicated earlier, rate shaping can be performed on the data transmitted between any two devices, and it is typically governed by the rate-shaping criteria for at least part of the link between the two devices. Additionally, as just indicated, rate shaping can also be nested by rate shaping both the cell phone flows and the tower flows.

The systems 200, 300 in FIGS. 2 and 3, respectively, illustrate the separation of the interfaces for low data-rate devices and for high data-rate devices. The port aggregators 270, 332a, 332b interface to the low data-rate devices, either directly or indirectly, and the network processors 230, 334a, 334b interface to the high data-rate devices. In FIG. 3, for example, port aggregator 332a interfaces indirectly to the low data-rate cell phone 310a, among others, and network processor 334a has a high data-rate interface to network processor 334b, among others. The terms port aggregator and network processor are merely descriptive and these interfacing functions may be separated in many ways, for example at the software, firmware, or hardware level. Further, in one implementation, these interfacing functions are not separated at all, and are performed by the same component or components.

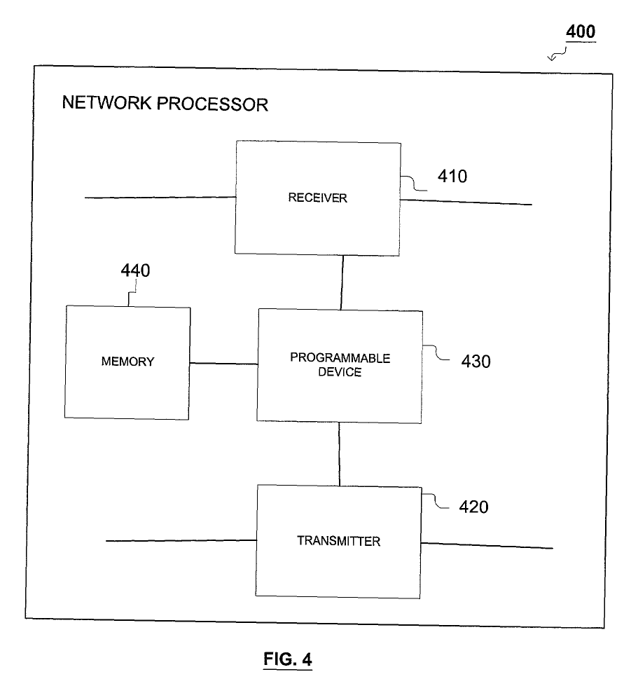

FIG. 4 shows the functionality of a network processor 400, which is analogous to network processors 230, 334a, 334b in the systems 200, 300 of FIGS. 2 and 3. The network processor 400 contains a receiver 410 for receiving data, a transmitter 420 for transmitting the received data, a programmable device 430 for performing rate shaping, and a memory 440 for buffering data and providing storage as needed by the programmable device 430. The programmable device 430 may be, for example, a microprocessor, an ASIC (“application specific integrated circuit”), a controller chip, or a programmed memory device or logic device. The programmable device 430 need not be reprogrammable by a user, and can have its functionality fixed using, for example, hardware or firmware. The network processor 400, or its component functions, may be implemented by one or more computers.

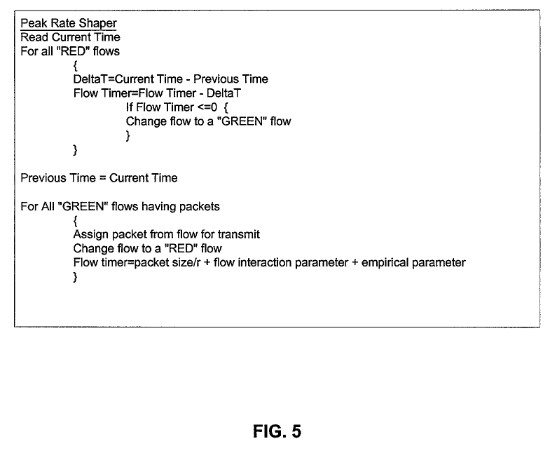

FIGS. 5-10 describe various processes associated with performing rate shaping on one or more flows. The processes are described with reference to the transmission of packets. However, the processes can be adapted to other units of data, including, for example, frames or protocol data units (“PDUs”). Further, the processes can be adapted to non-packet based systems or to any communication system having a limit on the amount of data transmitted at any given time.

The rate shaping performed enforces two rate-shaping criteria: a maximum burst size and a maximum long-term data rate. The maximum burst size is dictated by the maximum packet size because only one packet is transmitted at a time, with a wait period being required between any two packets being transmitted on a given flow.

The maximum long-term data rate is related to the length of the wait period between transmissions on a flow. Once a packet is authorized for transmission on a particular flow, that flow is required to wait a predetermined amount of time before another packet can be authorized for transmission. More generally, the flow is required to wait a predetermined amount of a time-based variable. The wait may be measured in time, in clock cycles, or using any other suitable variable. The length of the wait is a function of the length of the packet that was authorized for transmission. The term “authorized” is used here as a broad term, including, for example, sending a packet to a transmitter, assigning a packet to a transmission queue, actually transmitting the packet, removing a wait or hold state from the packet, and refraining from taking some action that would prevent the packet from automatically being transmitted.

FIG. 5 shows pseudo-code for one implementation. The pseudo-code may be used, for example, with the system 300 in FIG. 3. In the process described in FIG. 5, each flow is characterized by a single bit vector as being either red or green. Green indicates that the flow has waited the required amount of the time-based variable and is ready to be authorized to transmit data. Red indicates that the flow has not waited long enough since the last authorization. The pseudo-code begins by reading the current time, and then proceeds with different procedures for red flows and for green flows.

Each red flow is characterized by a flow timer that is analogous to a count-down timer. The waiting period for each flow is measured in time. Thus, for each red flow, the flow timer is updated by subtracting the amount of time that has elapsed since the last time the flow timer was checked. If the flow timer has expired, or elapsed, then the flow is changed to green. After each of the red flows is updated, the “previous time” variable is updated with the current time.

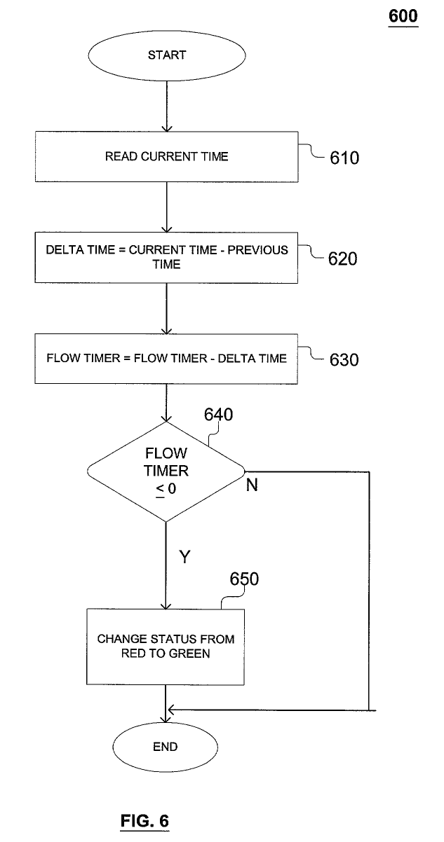

The general procedure for red flows, with small variations, is also shown in the flow chart 600 in FIG. 6. The current time is read (610) and “delta time,” the change in time, is calculated (620) by subtracting the previous time from the current time. The flow timer is then updated by subtracting delta time (630). “Previous time” and “flow timer” are stored values. The process 600 then determines if the flow timer has expired, that is, if the flow timer is less than or equal to zero (640). If the flow timer has expired, then the status of that flow is changed from red to green (650). If the flow timer has not expired, then the procedure ends for that flow.

A variety of mechanisms can be used to determine when next to update the flow timer. Various implementations may be embodied, for example, in software, firmware, hardware, or some combination, as appropriate to the application. One implementation bases the update rate on the smallest packet size, updating the flow timer between 3 and 5 times during the time required to transmit the smallest packet size at the long-term average data rate for that flow. For example, if the smallest packet size is 100 bytes and the long-term average data rate is 100 bytes/second, then the flow timer is updated between 3 and 5 times each second. A second implementation uses a count-down timer that triggers an interrupt when the timer has expired and the flow is ready to become green, obviating the need to update the flow timer regularly. A third implementation executes an infinite loop that repeatedly updates the flow timer at prescribed intervals that are subject to change because of intervening events such as interrupts.

Yet another implementation bases the update rate on time-based variables other than time. In particular, this implementation permits the selection of update variables for a rate shaper controlling three flows. As the table below indicates, the three flows have maximum long-term data rates of 155 megabits/second, 2 megabits/second, and 1.5 megabits/second. Each flow also supports the four different packet sizes of 64 bytes, 128 bytes, 256 bytes, and 1514 bytes, where each byte is 8 bits long.

Count-Down Value (number of clock cycles of a 166 MHz clock)

| Data Rate | Packet Size (8 bit bytes) | | | |
|---|---|---|---|---|
| (Mbps) | 64 | 128 | 256 | 1,514 |
| 155 | 548 | 1,097 | 2,193 | 12,972 |
| 2 | 42,496 | 84,992 | 169,984 | 1,005,296 |
| 1.5 | 56,661 | 113,323 | 226,645 | 1,340,395 |

The implementation is assumed to have a system clock operating at 166 megahertz, and the values in the body of the table specify the number of clock cycles that each flow must wait after authorizing a transmission of a particular size packet before another packet (of any size) can be authorized. Those values are determined by the following equation:

$$\begin{matrix}Value = \frac{packet size ( bytes ) * 8 ( bits \text{/} byte ) * 166 ( megacycles \text{/} second )}{data rate ( megabits \text{/} second )} \\ = \frac{packet size * 1328 ( cycles )}{data rate}\end{matrix}$$

These values are stored in the flow timer variable for each flow. Each of them represents a predetermined amount of a time-based variable, with the time-based variable being cycles of a clock.

As stated earlier, one implementation updates the flow timers between 3 and 5 times during the time needed to transmit the smallest packet on the flow. Using that guideline in the present implementation, the 155 megabits/second flow needs to have its flow timer, or count-down timer, updated every 100-200 clock cycles to accommodate 3-5 updates per transmission of a 64-byte packet. Because the flow timer is the only state variable that needs to be accessed, it can be maintained in a register, of a processor for example, rather than in memory. Further, because the count-down value for the largest packet size for this flow is less than 2**16, the flow timer for the fast flow can fit in a 16-bit register or half of a 32-bit register. In some implementations, the “previous time” variable, illustrated in FIG. 5, also needs to be stored. The previous time only needs to be stored to a precision of approximately 200 for the 155 megabits/second flow, requiring only 8 bits. Accordingly, both the flow timer and the previous time may be stored in the first 24 bits of a 32-bit register. These design choices enable a faster update, which is more important when the updates occur frequently.

For the two slower flows, the smallest count-down value is 42,496 and, using the 3-5 updates per packet guideline, it is sufficient to update the flow timers every 8,500-14,000 cycles. This is infrequent enough to warrant putting the flow timers in memory. A 21-bit variable accommodates the largest count-down value. However, because the data rate is slow and the update frequency is low, the granularity of the timer can be reduced. For example, a divide-by-64 clock can be used to divide the 166 megahertz clock by 64 so as to reduce the count-down values by a factor of 64, per the equation above, and allow the flow timers for the two slower flows to be stored in 16-bit variables.

Returning to FIG. 5, the pseudo-code next addresses green flows. Green flows that have no packet waiting to be authorized for transmission require no action. Thus, a green flow is processed only if it has a packet, in which case the packet is assigned, or authorized, for transmission; the flow is changed to red; and the flow timer is initiated. FIG. 5 provides an equation for calculating the new value for the flow timer. As shown, the equation includes the term “packet size/r” which reflects the amount of time needed to transmit the authorized packet at the flow rate, r. The new value is thus related to the maximum flow rate, r, which is one of the rate shaping criteria. The new value for the flow timer also includes, in the implementation of FIG. 5, two additional terms that are described further below.

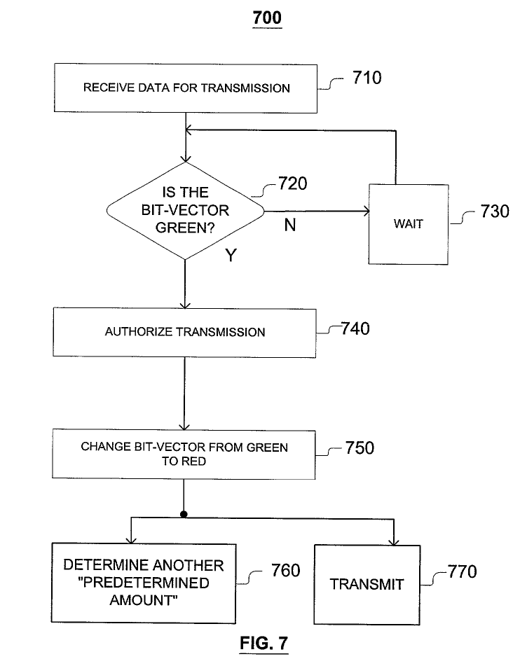

The general procedure for green flows, with small variations, is also shown in the flow chart 700 of FIG. 7. Data are received for transmission on a particular flow (710), and the bit vector for that flow is checked to determine if it is green (720). If the bit vector is not green, then the procedure waits (730) before checking the bit vector again. This waiting (730) can be implemented in many ways. In one implementation, the routine simply ends and begins again the next time that flow is checked for transmission requests. In a second implementation, the waiting (730) is based on a procedure for determining an optimal wait time such as by, for example, basing the wait time on the value of the flow timer for the flow.

If the bit vector for the flow is green, then transmission is authorized (740), the bit vector is changed from green to red (750), and another flow timer value is determined (760). The flow timer value is also referred to as the predetermined amount of a time-based variable that must elapse before another packet can be authorized for transmission. The flow timer need not be set when transmission is authorized, and need not expire before another transmission can be authorized. In one implementation in which authorization is a separate step from transmission, the flow timer is not set until after transmission occurs, as opposed to when the transmission is authorized. However, the authorization still examines the flow timer to determine if another transmission can be authorized. In such an implementation, it is necessary only that the flow timer substantially expire before the next authorization because the latency between authorization and transmission introduces additional delay. In a second implementation, this additional delay is determined empirically and is used to determine when the flow timer has substantially expired or elapsed, such that the remaining amount of “time” on the flow timer will be expected to elapse by the time that the authorized transmission actually occurs.

Returning to the flow chart 700 in FIG. 7, after the bit vector is changed from green to red (750), the packet is transmitted (770). Flow chart 700 indicates that actual transmission (770) can occur in parallel with at least some of the other steps. In particular, flow chart 700 shows that transmission (770) can occur in parallel with determining another flow timer value (760). In one implementation, transmission (770) occurs in parallel with changing the bit vector (750). In another implementation, transmission (770) is the same as authorizing transmission (740) and (again occurs in parallel with changing the bit vector (750).

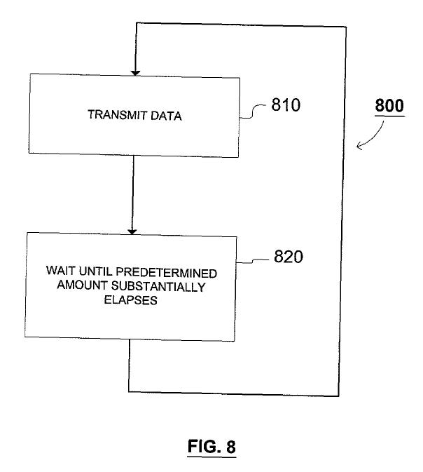

Flow chart 800 in FIG. 8 shows the process from the viewpoint of the transmitter. The transmitter transmits data (810), waits until a predetermined amount of a time-based variable has at least substantially elapsed (820), and then begins the process 800 again.

The procedure described in the pseudo-code of FIG. 5, as well as the combination of the processes 600, 700 in FIGS. 6 and 7, can be implemented in a variety of ways. At each transmission request, the flow timer and the bit vector may be updated. However, transmission requests can also be processed independently of flow timer updates. Such independent processing allows transmission requests to proceed swiftly in that only a single bit vector needs to be accessed for each flow before transmission can potentially be authorized on that flow. This is, in part, a result of the flow timer being independent of the size of the packet to be transmitted, and, instead, being based on the size of the previously-transmitted packet, such that no comparison needs to be performed.

One implementation performs this independent processing by maintaining a register with individual bits representing whether a transmission request is present on a given flow, and then masking that register with another register having bits indicating whether a given flow is green or red. The result of the mask has a “one” in those bit locations corresponding to flows that are green and have a transmission request, and the rate shaper then devotes its attention to those flows. In one such implementation, this processing of transmission requests for green flows occurs in an infinite loop, and flow timer updates are scheduled with timer-based interrupts. In another such implementation, the processing of transmission requests for green flows is interrupt-driven when a transmission request for one or more flows is received, and the flow timer updates are performed in an infinite loop calibrated for the appropriate update rate.

As indicated earlier, the implementations described in connection with FIGS. 5-8 allow only one packet to be transmitted at a time on each flow. This prevents a system that is receiving the transmitted packets from being overloaded with packet overhead.

Referring back to FIG. 5, the pseudo-code for the green flows states that the flow timer for that particular implementation includes a “flow interaction parameter” and an “empirical parameter.” The flow interaction parameter (“FIP”) models the impact of traffic from other flows sharing the link. The empirical parameter models system latencies such as the latency of the transmit function described earlier. These are described in turn.

It is often efficient for the rate shaper to authorize, or schedule, several packets for transmission. Because these packets, or the flows to which they belong, may share the same link, the exact time of transmission for each packet will be different. The rate shaper dynamically computes the impact of differing transmission times and accounts for the differing transmission time in the count down timer value for each flow. As an example of the impact of traffic sharing the link, consider the case where the rate shaper schedules three packets-Packet0, Packet1, and Packet2-having sizes L0, L1, and L2, respectively, to go out on flows I, J, and K, respectively, that share the same link. Assume that the packets go out in order and that the transmission rate on the link is R. Then FIPs, having units of time, are defined as follows:

FIP(I)=0

FIP(J)=L0/R

FIP(K)=(L0+L1)/R

These FIP values are added to the flow timers for the respective links, assuming that the flow timers are also expressed in units of time.

A variety of system latencies exist that influence the exact time at which a transmission occurs. These latencies can impact the overall average data rate, that is, the actual throughput, causing it to be below the allowable maximum data rate specified by the rate shaping criterion. Such latencies include, for example, the latency between the time that a transmission is authorized or scheduled and the time the transmission is picked up by the transmit function, internal latencies in the transmit function, and any buffering in a processor or external device. Further, there may be some variation in the flow rate that is observed on the link. Accordingly, in one implementation, an empirical parameter is introduced to account for these variations. The performance is empirically observed during testing or some other time period, and this parameter is adjusted until the performance is maximized. This parameter can be maintained on a per flow basis, to provide the needed flexibility in operation.

The procedure described with respect to FIGS. 5-8 can be compared with a token-bucket method of rate shaping. In a token-bucket method, tokens are deposited into a bucket at a prescribed rate, P, and the token level is indicated by L. Tokens are removed when a packet of data is transmitted, such that X tokens are removed when a packet of size X is transmitted. The bucket cannot have negative tokens, so a packet of size X cannot be transmitted until there are at least X tokens in the bucket, that is, until L is at least equal to X. Additionally, the bucket has a maximum size, B, such that it cannot accept more than B tokens. Thus, even if no packets need to be transmitted, the bucket will never accumulate more than B tokens.

The token-bucket method thus has three state variables associated with each flow: P, B, and L. These variables relate to two rate-shaping criteria that the token-bucket method enforces. The long-term data rate will not exceed P bits/second, assuming that P is specified in bits/second, because tokens are not accumulated any faster than that. Second, a burst transmission will never exceed B bits, assuming that B is specified in bits.

When a request is received to transmit a packet on a particular flow, the token-bucket rate shaper typically performs three tasks. First, the rate shaper computes a new value of L, based on P, B, and the elapsed time since L was last computed. Second, the rate shaper compares X with L. Third, one of two paths is taken depending on the previous comparison. If X is less than or equal to L, the rate shaper authorizes transmission of the packet, and subtracts X from L. Otherwise, if X is greater than L, the rate shaper does not authorize the packet for transmission and uses one of a variety of techniques to determine when to try again.

Thus, a token-bucket rate shaper typically accesses each of the three state variables for a given flow, in addition to determining elapsed time, each time a packet is received for transmission, even if the packet is not authorized for transmission. Further, the token-bucket method also requires computations to update L and to compare L to X before a decision can be made to authorize transmission. The implementations relating to FIGS. 5-8, however, need only typically access a single bit vector to determine if transmission can be authorized. As stated earlier, this advantage arises, in part, because the implementations relating to FIGS. 5-8 do not base the “wait” time on the size of the packet waiting to be transmitted.

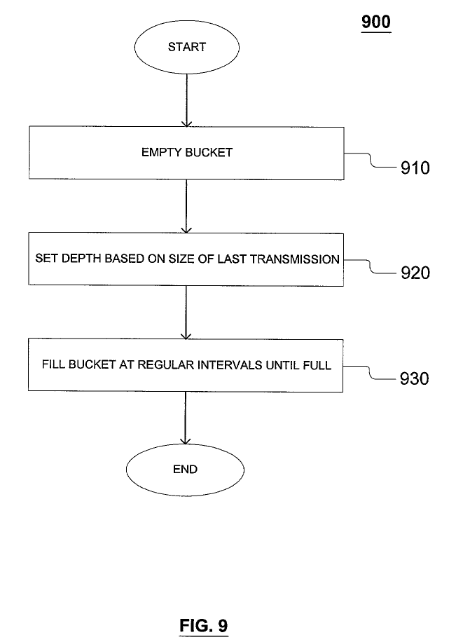

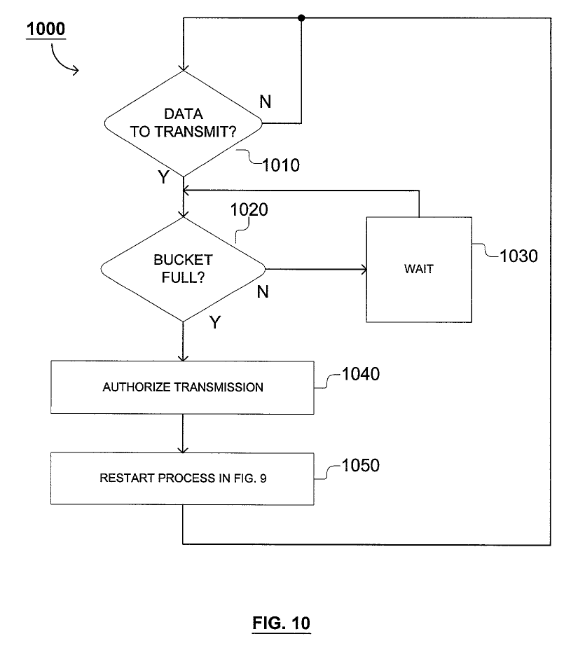

FIGS. 9 and 10 show processes 900, 1000 for adapting a typical token-bucket process to the procedure of FIG. 5. The process 900 in FIG. 9 focuses on updating the bucket and the process 1000 in FIG. 10 focuses on authorizing transmission. In FIG. 9, the bucket for a given flow is emptied (910), the depth, B, is set to the size of the last transmission (920), and the bucket is filled at regular intervals until it is full (930). At the same time, or serially, the implementation checks whether there is data to be transmitted on a particular flow (1010). When there is data to transmit, the implementation determines whether the bucket for that flow is full (1020). If the bucket is not full, the implementation waits (1030). As stated earlier in the context of another implementation, the waiting (1030) can be a continuous loop, a timed-event for rechecking the bucket, or some other technique appropriate to the application. If the bucket is full, then transmission is authorized (1040), the process 900 is reinitiated (1050), and the process 1000 begins looking for another transmission request (1010). The processes 900, 1000 may also implement a single bit vector based on whether the bucket for a given flow is full.

The various functions associated with performing rate shaping can be performed by a network processor, as indicated in the figures. A network processor can be, for example, a server or processor used by an ISP (“Internet Service Provider”) or other network access manager. Such devices may serve as the means for performing the described functions, including: determining whether to authorize transmission, authorizing transmission which can include transmitting, determining the predetermined amount of a time-based variable, waiting, and updating the flows including all state variables and other parameters. More particularly, the means may, in certain implementations, consist primarily of a processor or other programmable device, as indicated in FIG. 4, appropriately programmed, configured, or designed to perform specific functions.

A number of implementations have been described. Nevertheless, it will be understood that various modifications may be made without departing from the spirit and scope of the claims. Accordingly, other implementations are within the scope of the following claims.

What is claimed is:

1. A method for shaping data transmitted in a communication system, the method comprising:
determining whether to authorize transmission of received data having a variable size within a predetermined range, the determination being based on whether a predetermined amount of a time-based variable has substantially elapsed, the predetermined amount being related to a rate shaping criterion, and the determination being made without regard to the size of the received data;
authorizing transmission if the predetermined amount has substantially elapsed; and
determining, if transmission was authorized, a new value for the predetermined amount that must substantially elapse before a further transmission can be authorized.

2. The method of claim 1 further comprising:
receiving the received data; and
transmitting the received data.

3. The method of claim 1 wherein the received data is part of a flow.

4. The method of claim 2 wherein data are at least either received or transmitted in packets.

5. The method of claim 1 wherein the predetermined range includes multiple packet sizes in a packet-based system.

6. The method of claim 1 wherein determining whether to authorize transmission of the received data includes assessing a single bit vector, the single bit vector reflecting whether the predetermined amount has substantially elapsed.

7. The method of claim 1 further comprising determining whether the predetermined amount of the time-based variable has substantially elapsed.

8. The method of claim 7 wherein:
the rate shaping criterion comprises an average transmission data rate,
the time-based variable comprises cycles of a clock, and
the predetermined amount is not less than:
(the size of the previously transmitted data)*(the clock's frequency)/(the average transmission data rate).

9. The method of claim 8 wherein the new value for the predetermined amount is not less than:
(the size of the received data for which transmission was authorized)*(the clock's frequency)/(the average transmission data rate).

10. The method of claim 1 wherein the time-based variable is time.

11. The method of claim 1 wherein the predetermined amount is determined after a first transmission is authorized and completely elapses before a second transmission is authorized.

12. The method of claim 1 wherein the predetermined amount is determined after a first transmission and only substantially elapses before a second transmission is authorized.

13. The method of claim 1 wherein authorizing transmission comprises queuing a packet for transmission.

14. The method of claim 2 wherein the received data are at least either received or transmitted over a dedicated line.

15. The method of claim 2 wherein the received data are received from a wide area network and transmitted to a port aggregator.

16. The method of claim 2 wherein the received data are received from a port aggregator, and transmitted over a wide area network.

17. A computer program, residing on a computer-readable medium, for shaping data transmitted in a communication system, the data having a variable size within a predetermined range, the computer program comprising instructions for causing a computer to perform the following operations:
determine whether to authorize transmission of the data, the determination being based on whether a predetermined amount of a time-based variable has substantially elapsed, the predetermined amount being related to a rate shaping criterion, and the determination being made without regard to the size of the received data;
authorize transmission if the predetermined amount has substantially elapsed; and
determine, if transmission was authorized, a new value for the predetermined amount that must substantially elapse before a further transmission can be authorized.

18. The computer program of claim 17 wherein:
the rate shaping criterion comprises an average transmission data rate,
the time-based variable comprises cycles of a clock,
the instructions for causing the computer to determine whether to authorize transmission of the received data comprise instructions for causing the computer to assess a single bit vector, the single bit vector reflecting whether the predetermined amount of the time-based variable has substantially elapsed, and
the instructions for causing the computer to determine the new value comprise instructions for causing the computer to calculate the new value such that it is not less than:
(the size of the previously transmitted data)*(the clock's frequency)/(the average transmission data rate).

19. An apparatus for shaping transmitted data, the apparatus comprising a programmable device programmed to perform at least the following operations:
determine whether to authorize transmission of received data having a variable size within a predetermined range, the determination being based on whether a predetermined amount of a time-based variable has substantially elapsed, the predetermined amount being related to a rate shaping criterion, and the determination being made without regard to the size of the received data;
authorize transmission if the predetermined amount has substantially elapsed; and
determine, if transmission was authorized, a new value for the predetermined amount that must substantially elapse before a further transmission can be authorized.

20. The apparatus of claim 19 further comprising a memory to store data.

21. A communication system for shaping transmitted data, the system comprising:
means for determining whether to authorize transmission of received data having a variable size within a predetermined range, the determination being based on whether a predetermined amount of a time-based variable has substantially elapsed, the amount being related to a rate shaping criterion, and the determination being made without regard to the size of any received data;
means for authorizing transmission if the predetermined amount has substantially elapsed; and
means for determining, if transmission was authorized, a new value for the predetermined amount that must substantially elapse before a further transmission can be authorized.

22. The communication system of claim 21 wherein:
the means for determining whether to authorize transmission of received data comprises a programmable device programmed to assess a single bit vector, the single bit vector reflecting whether the predetermined amount of the time-based variable has substantially elapsed,
the means for authorizing transmission comprises the programmable device programmed to authorize transmission if the single bit vector reflects that the predetermined amount of the time-based variable has substantially elapsed, and
the means for determining another value comprises the programmable device programmed to determine the amount of the time-based variable that must substantially elapse before a further transmission can be authorized.

23. The communication system of claim 21 further comprising a receiver to receive the received data.

24. A modified token-bucket method for shaping data transmitted in a flow in a communication system, the method comprising:
providing a bucket for each flow, each bucket having a variable size depending on a size of a unit of data previously transmitted on the corresponding flow;
accumulating tokens in each bucket at an average flow rate for the corresponding flow;
authorizing transmission of a unit of data on a particular flow only when the corresponding bucket is full of tokens; and
removing all of the tokens from the bucket for a particular flow when a unit of data is authorized for transmission on that flow.

25. The method of claim 24 wherein authorizing transmission of the unit of data on the particular flow only when the corresponding bucket is full of tokens comprises assessing a single bit vector that reflects whether the bucket is full of tokens.

26. A method for shaping data transmitted in a communication system, the method comprising:
transmitting first data having a variable size within a predetermined range;
waiting, after transmitting first data, until a predetermined amount of a time-based variable has substantially elapsed, the predetermined amount being related to a rate shaping criterion and to the size of the first data; and
transmitting, after waiting, second data having a variable size within a predetermined range.

27. The method of claim 26 further comprising determining a new value for the predetermined amount, the new value being related to the rate shaping criterion and the size of the second data.

28. The method of claim 26 wherein the predetermined amount begins to elapse after the first transmission is authorized.
